(19) United States
(12) Patent Application Publication
(10) Pub. No.: US 2024/0053743 A1
(43) Pub. Date: Feb. 15, 2024

(54) Method for transferring control of a remote-controlled vehicle between at least two control entities

(71) Applicant: ORANGE, ISSY-LES-MOULINEAUX (FR)

(72) Inventors: Fanny Parzysz, CHÂTILLON CEDEX (FR); Antoine Mouquet, CHÂTILLON CEDEX (FR); Gaël Fromentoux, CHÂTILLON CEDEX (FR)

(21) Appl. No.: 18/257,930

(22) PCT Filed: Dec. 9, 2021
(86) PCT No.: PCT/FR2021/052268

§ 371 Date: Jun. 16, 2023

(30) Foreign Application Priority Data
Dec. 17, 2020 (FR) 2013559

(51) Int. Cl. G05D 1/00; G05D 1/10

(52) U.S. Cl. CPC G05D 1/0022; G05D 1/106

(57) ABSTRACT

A method for transferring to a second control entity control of a remotely-controlled vehicle, called a drone, from a first control entity exercising control of the drone via a first control data stream transmitted through a first communication session established between the first control entity and the drone. The method includes: detecting an event triggering transfer of control of the drone; determining the second control entity by using a list of control entities possessing an authorization for control of the drone, the list including at least one parameter relating to a condition for transferring control of the drone to the second control entity; and establishing transmission of a second control data stream through a second communication session between the drone and the second control entity, the establishment of the second control data stream contributing to an end of the control exercised by the first control entity over the drone.

### FIELD OF THE INVENTION

The field of the invention is that of remotely-controlled vehicles or drones. More specifically, the invention relates to the transfer of the control of a drone from a first control entity exercising control of the drone to a second control entity.

### PRIOR ART AND ITS DRAWBACKS

Remotely-controlled vehicles, more commonly known as drones, are remotely-piloted vehicles. This type of vehicle is increasingly used for uses as various as the analysis of transportation infrastructure (railways, power grid, road infrastructure), plotting of maps or the delivery of products to final consumers. These drones, most often of the aerial type, may also be rolling vehicles or used at sea. These are characterized by the fact that their pilot is not on board but at a distance from the vehicle, the latter being controlled using a control device. Indeed, the drone can be moved remotely by the pilot using the control device, or the drone can move autonomously, for example in accordance with the execution of a programmed travel plan, but always under the control of the pilot, who ensures the navigation of the drone in accordance with the programmed travel plan.

The use of drones is highly regulated, in particular because of security issues that might be induced by the presence of the drone in a place in which its presence is not authorized, and the pilot ensuring remote steering of the drone must, nowadays, have the drone in his field of vision. Furthermore, the drones or UAV (Unmanned Aerial Vehicle) currently used communicate very little when they are in action, for example in flight. Typically, only some drone control data are exchanged with the control device when the drone is in action. The data relating to the mission of the drone (example: transportation infrastructure analysis) are most often recorded when the drone is put into action, for example on a memory card, and this memory card is recovered to be played when the drone returns to the base after completing its mission.

The Global System for Mobile Communications Association or GSMA like the Third Generation Partnership Project or 3GPP, in particular in the document referenced 3GPP TS 22.125 V17.2.0: Unmanned Aerial System (UAS) support in 3GPP; Stage 1; Release 17—September 2020, consider that both the drone and the pilot should be authenticated, for example by using a SIM card (Subscriber Identification Module) or eSIM, guaranteeing that the public or private space is not occupied by an unidentified remotely-controlled vehicle. Correspondingly, solutions are offered for the identification and registration of drones, for the access of drones to the public domain or for the detection of corrupt drones.

A drone and its pilot being identified and located at all times, the safety of all actors impacted by activities related to the use of drones is thereby improved.

The next evolution of this technology will undoubtedly be based on drones moving in a space that will be out of the field of vision of the pilot (BVLoS—Beyond Visual Line of Sight), thereby allowing for the possibility of offering a wider range of services (surveillance, communication of media streams, dissemination of information following a disaster, etc.) from a drone. In such a scenario, as well as in other situations where the drone remains in the field of vision of the pilot, the question arises of the change of pilot controlling the drone during its mission. Indeed, even though it will no longer be necessary for the drone to be in the field of vision of the pilot, the drone may find itself, during its mission, outside an area of responsibility of a pilot who will then have to pass hand to another pilot or in a situation where a pilot would fail, etc.

Continuity in the exercise of control of a drone in all circumstances is made possible by enabling the transfer of control of the drone from one control device to another.

The procedure for transferring control of the drone is implemented within a drone traffic management system or UTM (UAVTraffic Management System). Thus, when an entity of the drone traffic management system is informed on the occurrence of an event requiring the transfer of control of a drone from a first control entity to a second control entity, a procedure for issuing a drone control authorization to a new control device is implemented within the drone traffic management system. Once the drone control authorization has been issued to the new control device, the drone traffic management system transmits, to at least one piece of equipment belonging to a system for managing the connectivity of remotely-controlled systems, messages requesting the establishment of a transmission channel with the new control device of the drone. A remotely-controlled system consists of a drone and a control device provided with a drone control authorization exercising control of the latter. Upon reception of these messages, the various pieces of equipment of the system for managing the connectivity of remotely-controlled systems proceeds with the establishment of a transmission channel between the drone and the control device to which control of the drone is intended to be transmitted.

However, such a method for transferring control of a drone between two control devices is a long procedure with regards to the responsiveness required by the situation since the drone traffic management system should be informed of the occurrence of an event in order to trigger, often manually, the process of transferring control of the drone then, once the new control device has been authorized, it should inform afterwards the system for managing the connectivity of the remotely-controlled systems so that the data transfer is effective. In addition, such a method does not guarantee that a drone is controlled, at a given instant, by a unique control device.

Hence, there is a need for a technique allowing transferring control of a drone from one pilot to another which does not have all or some of the aforementioned drawbacks.

### DISCLOSURE OF THE INVENTION

The invention addresses this need by providing a method for transferring to a second control entity the control of a remotely-controlled vehicle, called a drone, from a first control entity exercising control of the drone via a first control data stream transmitted throughout a first communication session established between said first control entity and the drone.

Such a method for transferring control of a remotely-controlled vehicle comprises the following steps:
detecting an event triggering the transfer of control of said drone,
determining said second control entity by means of a list of control entities possessing an authorization for control of said drone, said list comprising at least one parameter relating to a condition for transferring control of said drone to said second control entity,
establishing the transmission of a second control data stream throughout a second communication session between the drone and said second control entity, the establishment of the transmission of said second control data stream throughout the second communication session contributing to the end of the control exercised by the first control entity over the drone.

In the present document, by control entity of a drone, it should be understood a device for controlling a drone, a drone pilot, whether a human being or an autopilot, or a pair consisting of a pilot and a device for controlling a drone.

The interest of the present solution lies in the fact that within the same system, such as a system for managing the connectivity of remotely-controlled systems, the event triggering the transfer is detected, an entity already authorized to control the drone is identified and the transmission of a new control data stream emitted by the control entity intended to exercise control of the drone is triggered, and finally it is ensured that only the new control entity can exercise control of the drone by ensuring that the transmission of a new control data stream puts an end to the transmission of a control data stream emitted by the control entity previously exercising control of the drone.

Indeed, the centralization of all these operations and all this information within the same system allows transferring the exercise of control of the drone quickly to the selected control entity. This also allows quickly and simply obtaining the information required for the transfer of control of the drone, this information being recorded in the list of control entities intended to control said drone.

The use of a list comprising only control entities having an authorization for control of the drone in order to determine to which control entity to transfer control of a drone on mission contributes to reducing the duration of transfer operations and the limitation of data exchanges between the different management systems. If a change in the control entities is scheduled, a control transmission channel may also be established between the drone and the new control entity, and intended to support a communication session between the drone and the new control entity even before the effective triggering of the change procedure, ensuring an even better fluidity of operations since when it is time to actually transfer control of the drone to the new control entity, all that remains is to trigger the transmission of a control data stream by the selected control entity.

Thus, the transfer procedure according to the method object of the present invention is more fluid and guarantees satisfactory continuity of service.

In addition, the fact that the transmission of a control data stream by the selected control entity terminates the transmission of a control data stream emitted by the control entity that has previously exercised control of the drone guarantees that at all times the control of the drone is ensured only by a unique control entity.

According to a particular feature of the method for transferring control of a drone, the at least one parameter relating to a condition for transferring control of said drone to said second control entity is a transfer priority level associated with said second control entity.

By associating a priority level with the different control entities intended to control the drone, the process of determining the control entity to which to transfer control of the drone is thereby facilitated and accelerated.

According to another particular feature of the method for transferring control of a remotely-controlled vehicle, said second entity is also determined by means of a parameter representative of the event triggering the transfer of control of the drone.

Indeed, depending on the nature of the triggering event, a control entity having a lower priority level than other control entities from the list of control entities intended to control the drone may be selected because it is better suited to the context in which the control transfer occurs.

In a particular implementation of the control transfer method object of the invention, the at least one parameter relating to a condition for transferring control of said drone to said second control entity is a parameter representing a status of exercise of control of the drone by said second entity, said method comprising:
a step of modifying said parameter representing a status of exercise of control of the drone by said second entity from inactive to active, triggering the transmission of the second control data stream.

Thus, it is always indicated in the list of control entities intended to control the drone which control entity actually exercises control of the drone, at the moment when the list is consulted.

In such a particular implementation of the control transfer method, the modification of the priority level associated with the first control entity or with the second control entity in said list of control entities intended to control said drone, the modification of the priority level associated with the first control entity or with the second control entity triggering the transmission of the second control data stream.

Finally, the event triggering the transfer of control of said drone may belong to the following list comprising:
a crossing of a geographical limit or an altitude of said drone,
a cutoff in a transmission channel established between the first control entity exercising control over the drone and a drone connectivity management system, said transmission channel supporting a communication session established between the first control entity exercising control over the drone and the drone,
an insufficient service quality of the transmission channel established between the first control entity exercising control over the drone and a drone connectivity management system,
a reception of a request to transfer control of the drone emitted by a drone traffic management entity,
a reception of a request to transfer control of the drone emitted by a drone fleet management entity to which the drone belongs,
a reception of a request to transfer control of the drone emitted by a control entity belonging to a list of control entities,
a reception of a request to transfer control of the drone emitted by the drone itself,
an automatic detection of an alert on an infrastructure that justifies a control entity change,
a detection of an injunction from accredited authorities.

It arises that many types of events, considered separately or in combination, could trigger the transfer of control of a drone to another control entity. Thus, the transfer method object of the invention allows dealing with a wide range of situations, among which mention may also be made of the reception of an alert indicating the need to change pilots. Such alerts may be automatically triggered by an event during a process related to the mission of the drone (for example: automatic detection of an anomaly on an infrastructure), a diagnostic type event, indicating a failure of the system (for example: a problem with the electric power supply of the drone, short-circuit, overheating, etc.), or an event related to maintenance or prevention (for example: a risky piloting, a component of the drone requiring maintenance, etc.) Another object of the invention relates to a method for managing a list of remotely-controlled vehicle control entities intended to control a remotely-controlled vehicle, called a drone.

Such a method comprises the following steps:
receiving a request to modify said list of control entities relating to a control entity,
verifying the possession, by said control entity, of an authorization for control of said drone,
when said control entity possesses an authorization for control of said drone, recording in an entry in said list of control entities comprising at least the identifier of said control entity, and at least one parameter relating to a condition for transferring the control of said drone to said control entity.

As already explained in connection with the method for transferring control of a drone, the management and use of a list comprising only control entities possessing an authorization for control of the drone in order to determine to which control entity to transfer control of a drone on a mission contributes to reducing the duration of transfer operations and limiting data exchanges between the different management systems.

Such a list of control entities authorized to control a drone can be easily updated.

According to a particular feature of the method for managing a list of control entities, the at least one parameter relating to a condition for transferring control of said drone to said control entity comprises:
a transfer priority level associated with said control entity,
at least one rule for transferring control of the drone to said control entity.

By associating a priority level with the different control entities intended to control the drone, the process of determining the control entity to which to transfer control of the drone is thereby facilitated.

The drone control transfer rules allow determining, when several control entities have the same priority level, which control entity should be selected for the control transfer.

According to a particular feature of the method for managing a list of control entities, the list of control entities further comprises at least one parameter relating to an access right of said entity to the content of said list.

Depending on the access rights granted thereto, a control entity can itself modify information stored in the list concerning it, such as in particular its transfer priority level or the values of the rules for transferring control of the drone.

According to another particular feature of the method for managing a list of control entities, the control entity associated with a transfer priority level lower than the transfer priority levels associated with the other control entities present in the list is a default control entity of said drone.

Thus, irrespective of the circumstances, there is always a control entity able to exercise control of the drone.

In a particular implementation of the method for managing a list of control entities, the latter further comprises a step for resolving transfer priority conflicts between at least two control entities associated with the same transfer priority level, said step comprising:
identifying amongst said at least two control entities a control entity intended to be associated with a transfer priority level modified by means of a parameter belonging to the following list comprising:
a parameter representative of a service quality required by said control entity,
a security parameter,
a geographic and/or time limit,
a rule pre-established by any authorized entity,
modifying the transfer priority level associated with said selected control entity to another priority level.

This allows ensuring that two distinct control entities associated with the same priority level could nevertheless be classified with regards to the control of a particular drone. This facilitates the determination of the control entity to which control of the drone should be transferred.

The invention also relates to a device able to perform a transfer to a second control entity of the control of a remotely-controlled vehicle, called a drone, from a first control entity exercising control of the drone by means of a first control data stream transmitted throughout a first communication session established between said first control entity and the drone.

Such a device comprises:
a module for detecting an event triggering the transfer of control of said drone,
a module for determining said second control entity by means of a list of control entities possessing an authorization for control of said drone comprising at least parameters relating to conditions for transferring control of said drone to said second control entity,
a module for transmitting a second control data stream throughout a second communication session between the drone and said second control entity, the establishment of the transmission of said second control data stream throughout the second communication session contributing to the end of the control exercised by the first control entity over the drone.

For example, such a device is a server of a system for managing the connectivity of remotely-controlled systems.

Another object of the invention relates to a device able to manage a list of remotely-controlled vehicle control entities intended to control a remotely-controlled vehicle, called a drone.

Such a device comprises:
a module for receiving a request to modify said list of control entities relating to a control entity,
a module for verifying the possession, by said control entity, of an authorization for control of said drone,
a module for recording an entry in said list of control entities comprising at least the identifier of said control entity, and parameters relating to the conditions for transferring control of said drone to said control entity, when said control entity possesses an authorization for control of said drone.

For example, such a device is a server of a system for managing the connectivity of remotely-controlled systems.

Finally, the invention relates to computer program products comprising computer program code instructions for the implementation of the methods as described before, when these are executed by a processor.

The invention also relates to a computer-readable storage medium on which computer programs are recorded comprising program code instructions for the execution of the steps of the methods according to the invention as described hereinabove.

Such a storage medium may be any entity or device capable of storing the programs. For example, the medium may include a storage means, such as a ROM, for example a CD-ROM or a ROM of a microelectronics circuit, or a magnetic storage means, for example a flash disk or a hard disk.

On the other hand, such a storage medium may be a transmissible medium such as an electrical or optical signal, which may be conveyed via an electrical or optical cable, by radio or by other means, so that the computer programs it contains can be executed remotely. In particular, the programs according to the invention may be downloaded from a network, for example the Internet network.

Alternatively, the storage medium may be an integrated circuit in which the programs are embedded, the circuit being adapted to execute or to be used in the execution of the aforementioned methods objects of the invention.

### LIST OF THE FIGURES

Other aims, features and advantages of the invention will appear more clearly upon reading the following description, given as a simple illustrative and non-limiting example, with reference to the figures, wherein:

FIG. 1: this figure represents the different elements involved in the implementation of this solution,

FIG. 2: this figure represents the different steps of a method for managing a list of control entities intended to control a drone,

FIG. 3: this figure represents the different steps of such a method for transferring control of the drone,

FIG. 4: this figure represents a server able to implement the methods for managing a list of control entities and for transferring control of a drone objects of the invention.

### DETAILED DESCRIPTION OF EMBODIMENTS OF THE INVENTION

The general principle of the invention is based on the creation and management of a list of control entities intended to take control of a given drone. Such a list of control entities is particular because it includes only control entities possessing an authorization for control of the drone issued by a certified entity such as for example a managing entity of a drone traffic management system or UTM (UAV Traffic Management System) whose main function is to regulate the drone traffic in order to ensure an efficient and secure cohabitation of the drones with other vehicles, remotely-controlled or not, sharing the same space.

Another specificity of such a list of control entities is that it is maintained in a piece of equipment of a system for managing the connectivity of remotely-controlled systems. For example, such a system for managing the connectivity of remotely-controlled systems is a system such as that one described in the publication 3GPP TR 23.754 V2.0.0: Study on supporting Unmanned Aerial Systems (UAS) connectivity, Identification and tracking (Release 17)—November 2020.

The system for managing the connectivity of remotely-controlled systems interacts with cellular and wired communication networks and consequently constitutes a point for gathering data relating to all kinds of events relating to remotely-controlled vehicles, their control entities or the networks that connect them.

Thus, by ensuring the creation and maintenance of this list of control entities in such a system for managing the connectivity of remotely-controlled systems, it becomes possible to facilitate and improve the procedure for transferring control of a drone from a first control entity to a second control entity since it is within the same system that both the information relating to an event triggering a transfer of control of a drone is collected, and the connectivity between the drone and the control entities involved in the transfer of control of the drone is managed. Such an implementation avoids data exchanges between the drone traffic management system and the system for managing the connectivity of remotely-controlled systems as is the case in existing solutions.

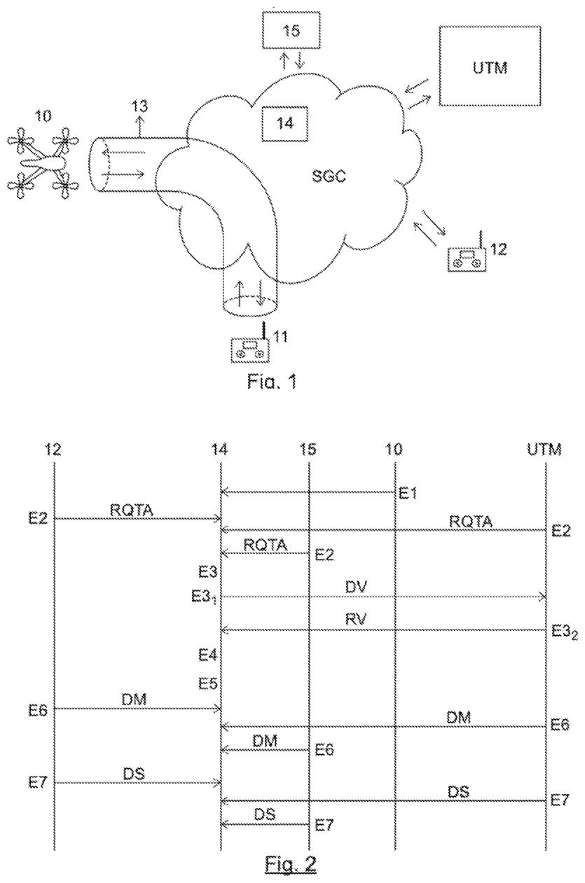

The different elements involved in the implementation of this solution are now disclosed with reference to [FIG. 1].

Thus, a remotely-controlled vehicle 10 in mission, such as a drone for example, is controlled by a first control entity 11. Such a drone 10 belongs to a fleet of drones managed by a drone fleet management entity 15. For example, such a drone fleet management entity 15 is a company delivering goods to homes or a company monitoring industrial sites.

Such a control entity 11 exercises control of the drone 10 by transmitting a first control data stream throughout a communication session 13 established between the drone 10 and the control entity 11. Such a communication session is supported by one or more transmission channel(s) established between the control entity 11 and the drone 10. The establishment and maintenance of these communication channels are performed by a piece equipment of a system SGC for managing the connectivity of remotely-controlled systems with which the drone 10 and the control entity 11 are identified.

Thus, in a first implementation, a first transmission channel, such as a PDU (Protocol Data Unit) channel, is established between the drone 10 and the system SGC for managing the connectivity of remotely-controlled systems, for example via a gateway of a mobile network, and a second transmission channel, such as a PDU channel, is established between the system SGC for managing the connectivity of remotely-controlled systems, via the same gateway or a separate gateway, and the control entity 11. In this first implementation, the communication session throughout which the control entity 11 exercises control of the drone 10 is supported by these two PDU channels which are connected to each other by the system SGC for managing the connectivity of remotely-controlled systems.

In a second implementation, a first transmission channel, such as a PDU channel, is established between the drone 10 and the system SGC for managing the connectivity of remotely-controlled systems, and a second transmission channel, such as an IP (Internet Protocol) session, is established between the system SGC for managing the connectivity of remotely-controlled systems and the control entity 11. In this second implementation, the communication session throughout which the control entity 11 exercises control of the drone 10 is supported by the PDU channel and the IP session which are connected together by the system SGC for managing the connectivity of remotely-controlled systems.

In a third implementation, a unique transmission channel, such as a PDU channel or an IP session, is established between the drone 10 and the control entity 11.

Other types of transmission channels and other combinations of these different types of transmission channels may be considered in the context of the present invention.

Regardless of the selected implementation, the transmission channel(s) established between the drone 10 and a control entity supports at least one first communication session, called the control session, throughout which the control entity 11 exercises control of the drone 10 by transmitting the first control data stream. In some cases, the transmission channel(s) established from the drone 10 may support additional communication sessions, called data sessions, throughout which the drone also exchanges data with the control entity 11 or any other equipment with which drone 10 needs to exchange data. Hence, the transmission channel used for the control entity 11 to transmit the first control data stream from the drone 10 may be specific to the communication session established for the control or be shared with other communication sessions established for purposes other than control.

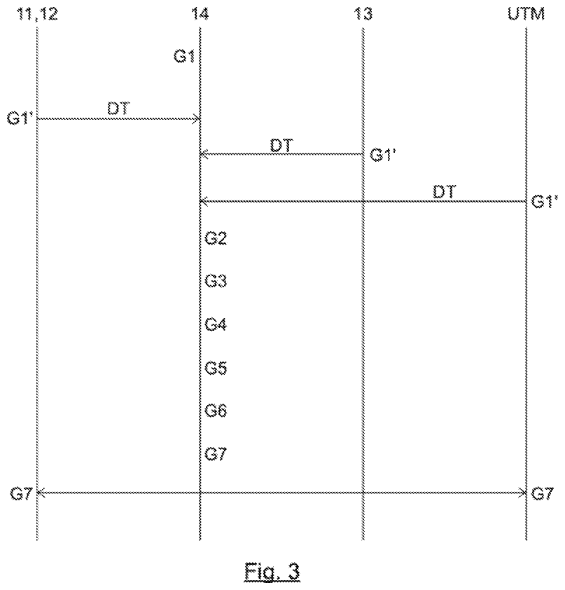

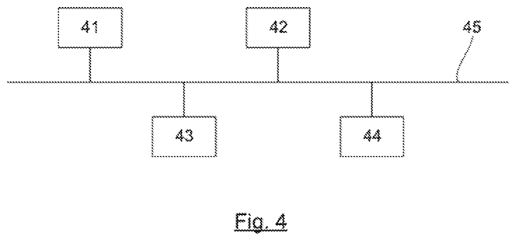

A second control entity 12 is also identified before the system SGC for managing the connectivity of remotely-controlled systems and is waiting to be called upon to take control of the drone 10. The system SGC for managing the connectivity of remotely-controlled systems comprises, inter alia, a server 14 whose function will be described with reference to FIGS. 2 and 3 described later on.

The system SGC for managing the connectivity of remotely-controlled systems communicates with a drone traffic management system UTM. Such a drone traffic management system UTM manages drone traffic in order to limit and possibly avoid accidents between drones or with other controlled or uncontrolled vehicles. To this end, the drone traffic management system UTM is authorized to issue movement authorizations to the drones 10 as well as control authorizations to the control entities 11, 12. Thus, only an authorized drone 10 can perform a mission. Similarly, only one authorized control entity 11, 12 can exercise control of a drone.

In the context of a procedure for transferring control of a drone 10, a list L10 of control entities 11, 12 intended to actually be able to control the drone 10 is created and stored in a piece of equipment of the system SGC for managing the connectivity of remotely-controlled systems. Such a list of control entities 11, 12 is created and stored for a set of drones identified with the system SGC for managing the connectivity of remotely-controlled systems.

Referring to [FIG. 2], the different steps of a method for managing a list of control entities intended to control a drone are described. For example, these steps may be implemented by a server belonging to the system SGC for managing the connectivity of remotely-controlled systems.

Thus, in a step E1, the registration of the drone 10 with the server 14 belonging to the system SGC for managing the connectivity of remotely-controlled systems triggers the creation of a list L10, specific to the drone 10, which is intended to comprise all control entities 11, 12 that can alternately exercise control of the drone 10.

For example, the registration of the drone may consist of a procedure for attaching a mobile terminal, on board the drone 10, to a base station belonging to the system SGC for managing the connectivity of remotely-controlled systems or the registration of the drone itself with a communication network.

Once the list L10 has been created, its content is completed and modified according to the needs expressed, for example, by a drone fleet management entity 15 to which the drone 10 belongs and/or according to the constraints expressed by the drone traffic management entity UTM.

In this exemplary implementation, a first control entity 11 is already included in the list L10. Like the drone 10, such a control entity 11 is registered beforehand with the server 14 belonging to the system SGC for managing the connectivity of remotely-controlled systems. Thus, transmission channels are established on the one hand between the drone 10 and a piece of equipment belonging to the system SGC for managing the connectivity of remotely-controlled systems and on the other hand between the control entity 11 and a piece of equipment belonging to the system SGC for managing the connectivity of remotely-controlled systems, which could be the same as that one involved in the establishment of the transmission channel of the drone 10.

The entry of the list L10 corresponding to the control entity 11 comprises at least one first field in which an identifier ID11 of the control entity is recorded. Other parameters relating to the conditions for transferring control of the drone 10 to the control entity 11 are recorded in other fields of the list L10 which will be discussed later on. Finally, the control entity 11 possesses an authorization AC11 for control of the drone 10 issued by the drone traffic management system UTM.

In a step E2, the server 14 receives a request RQTA to add a second control entity 12 to said list L10 of control entities. Such a request RQTA comprises an identifier ID12 of the control entity 12 to be added to the list L10. The control entity 12 is also registered beforehand with the server 14 belonging to the system SGC for managing the connectivity of remotely-controlled systems. Thus, a transmission channel is established between the control entity 12 and a piece of equipment belonging to the system SGC for managing the connectivity of remotely-controlled systems. In a particular embodiment, at least one communication session may also be established between the second control entity 12 and the drone 10.

In a first implementation of the present solution, the request RQTA is emitted by a piece of equipment belonging to the drone traffic management system UTM.

In a second implementation of the present solution, the request RQTA is emitted by a piece of equipment belonging to the drone fleet management entity 15 to which the drone 10 belongs.

Finally, in a third implementation of the present solution, the request RQTA is emitted by the control entity 12 itself.

Since only a duly authorized control entity 12 can be added to the list L10, upon reception of the request RQTA, the server 14 verifies, during a step E3, whether the control entity 12 has an authorization AC12 for control of the drone 10 emitted by the drone traffic management system UTM.

When the request RQTA has been emitted by a piece of equipment belonging to the drone traffic management system UTM, the verification performed during step E3 consists, for example, in verifying that the equipment emitting the request RQTA belongs to the drone traffic management system UTM. Indeed, assuming that the authorizations to control a drone are issued by the drone traffic management system UTM, it is estimated in this first implementation that any addition request RQTA emitted by a piece of equipment of the drone traffic management system UTM necessarily concerns a control entity authorized by the drone traffic management system UTM.

When the request RQTA has been emitted by a piece of equipment belonging to the drone fleet management entity 15 to which the drone 10 belongs or by the control entity 12 itself, the verification performed during step E3 comprises several sub-steps. In a first sub-step E3₁, the server 14 emits a control authorization verification request DV before a piece of equipment of the drone traffic management system UTM. For example, such a verification request comprises the identifier ID12 of the control entity whose control authorization AC12 is to be verified as well as an identifier ID10 of the drone 10 that the control entity 12 might have to control.

Upon reception of this verification request DV, the equipment of the drone traffic management system UTM verifies, by means of the identifiers ID12 of the control entity and ID10 of the drone 10, whether an authorization AC12 for control of the drone 10 has been issued for the control entity 12.

In a sub-step E3₂, the equipment of the drone traffic management system UTM having proceeded with the verification emits a response RV to the server 14. Depending on the nature of the response, the control entity 12 is added to the list L10, or not.

In another implementation, the authorization AC12 for control of the drone 10 is included in a field of the request RQTA. The server 14 then accesses the content of this field of the request RQTA in order to verify whether the control entity 12 possesses an authorization AC12 for control of the drone 10.

When it is established by the server 14 that the control entity 12 possesses an authorization AC12 for control of the drone 10, an entry corresponding to the control entity 12 is created in the list L10 during a step E4.

Such an entry comprises a first field in which the identifier ID12 of the control entity 12 is recorded. The parameters relating to the conditions for transferring control of the drone 10 to the control entity 12 comprise a transfer priority level NP12 associated with the control entity 12. Such a transfer priority level NP12 is recorded in a specific field of the list L10.

The parameters relating to conditions for transferring control of drone 10 to the control entity 12 also comprise a list of conditions for transferring control of the drone 10 to the control entity 12 such as for example:
a crossing of a geographical limit or an altitude of the drone 10,
a cutoff in a transmission channel established between the control entity 11 exercising control over the drone and a drone connectivity management system SGC, said transmission channel supporting a communication session established between the control entity 11 exercising control over the drone and the drone 10,
an insufficient service quality of the transmission channel established between the control entity 11 exercising control over the drone 10 and a drone connectivity management system SGC,
a reception of a request to transfer control of the drone 10 emitted by a drone traffic management entity,
a reception of a request for transfer of control of the drone emitted by a drone fleet management entity to which the drone 10 belongs,
a reception of a request to transfer control of the drone emitted by a control entity belonging to a list of control entities,
a reception of a request to transfer control of the drone emitted by the drone 10 itself,
an automatic detection of an anomaly on an infrastructure that justifies a pilot change,
a detection of an injunction from accredited authorities, etc.

Such a list of conditions for transferring control of drone 10 to the control entity 12 is recorded in one or more field(s) of the list L10.

In order to determine which transfer condition(s) trigger(s) the transfer, a possible implementation may consist in browsing a list of transfer conditions for which it is verified whether they are met or not:

```
  if < crossing of a geographical limit > then...
  else
  if < other condition > then ... else...
  or:
  if <injunction from accredited authorities >, then <
  control entities accredited by these same
authorities have priority over all until further notice>
```

In one embodiment of the method for managing the list L10, the parameters relating to the conditions for transferring control of the drone 10 to the control entity 12 comprise, in addition to a transfer priority level NP12, a parameter representing a status of exercise of control of the drone 10 by the control entity 12. Such a parameter representing a status of exercise of control of the drone 10 may be presented, for example, in the form of an ACTIVE or INACTIVE flag depending on whether or not the control entity 12 actually exercises control of the drone 10.

Regardless of the embodiment of the method for managing the list L10, the latter also comprises a parameter relating to access rights to the content of the entry of the list L10 relating to the control entity 12. This parameter indicates which equipment, such as for example the equipment of the drone traffic management system UTM or the equipment belonging to the drone fleet management entity 15 to which the drone 10 belongs or of the control entity itself, have an access right to the content of the entry of the list L10 relating to the control entity 12. In particular, these access rights are a read access right and a write access right. Of course, other types of access rights may be considered.

All these parameters, whether the parameters relating to the conditions for transferring control of the drone 10 to the control entity 12 or the parameter relating to access rights to the content of the entry of the list L10 relating to the control entity 12, may be received by the server 14 via the addition request RQTA or may be provided at another time by any one of the equipment of the drone traffic management system UTM or the drone fleet management entity 15 to which the drone 10 belongs or by the control entity 12 itself or another control entity.

During a step E5, which may be implemented each time a new entry is created in the list L10 or an entry in the list L10 is modified, the server 14 resolves transfer priority conflicts that might intervene between at least two control entities 11, 12 associated with the same transfer priority level NP11, NP12.

Thus, when a first control entity 11 of the list L10 a value of a transfer priority level NP11 of which is identical to a value of a transfer priority level NP12 of a second control entity 12 of the list L10, the server 14 modifies the transfer priority level NP associated with either one or both control entities 11, 12 so that they have both a value distinct from the transfer priority level NP. In order to determine which one of the two control entities 11, 12 should have a higher value of the transfer priority level NP, the server 14 identifies amongst the set of parameters stored in the entries of the list L10 corresponding to each of the concerned control entities 11, 12 those whose value allows determining a transfer priority level NP. If the parameters recorded in the list L10 in connection with a given control entity are not sufficient to enable the server 14 to resolve the priority level conflict, the latter may exchange messages with a piece of equipment of the drone traffic management system UTM, with a piece of equipment of the drone fleet management entity 15 to which the drone 10 belongs, or with another piece of equipment belonging to the system SGC for managing the connectivity of remotely-controlled systems.

For example, the server 14 may use the parameter representative of the minimum service quality required for the transmission channel(s) established between the control entity and the drone 10. The server 14 may also use security parameters, for example if one of the control entities belongs to the traffic management system UTM of the drone. Indeed, it may be considered that such a control entity has a high level of confidence and can therefore, in the context of the resolution of a conflict of transfer priority levels, be assigned a value of a modified transfer priority level higher than another control entity.

During the use of the list L10, the content of the latter is modified. Indeed, new entries corresponding to new control entities that can control the drone 10 are created. In order to keep a list L10 up to date and thus offer the most satisfactory service quality possible, the content of the existing entries of the list L10 may be modified in order to update the values of some parameters recorded in the list L10.

Thus, in a step E6, the server 14 may receive a request DM for modifying one or more parameter(s) of an entry in the list L10. Such a modification request DM may be emitted by a piece of equipment belonging to the drone traffic management system UTM, by a piece of equipment belonging to the drone fleet management entity 15 to which the drone 10 belongs or by the control entity 12 itself or another control entity.

Upon reception of the modification request DM, the server 14 verifies whether the equipment having transmitted this modification request DM has write access rights for this entry of the list by consulting the field of the list L10 in which this information is stored. If so is the case, the server 14 proceeds with the requested modification and updates the entry of the list L10 relating to the control entity 12. If such a modification generates a transfer priority level conflict, the server 14 implements step E5 in order to resolve the conflict.

During the use of the list L10, it may also happen that a control entity 11, 12 can no longer control the drone 10 for various reasons: it is no longer authorized by the drone traffic management system, it is down or out of order, etc. In such circumstances, it might be necessary to delete the corresponding entry from the list L10.

To this end, in a step E7, the server 14 may receive a request DS for deleting an entry from the list L10. Such a deletion request DS may be emitted by a piece of equipment belonging to the drone traffic management system UTM, by a piece of equipment belonging to the drone fleet management entity 15 to which the drone 10 belongs or by the control entity 12 itself or another control entity.

Upon reception of the deletion request DS, the server 14 verifies whether the equipment having transmitted this deletion request DS has write access rights for this list entry by consulting the field of the list L10 in which this information is stored. If so is the case, the server 14 deletes the considered entry. If such a modification generates a transfer priority level conflict between some control entities still present in the list L10, the server 14 implements step E5 in order to resolve the conflict.

Finally, in order to ensure that control of the drone could be exercised irrespective of circumstances, it is possible to define in the list L10 a control entity of the drone 10 by default. Such a control entity is the control entity to which the transfer of control of the drone 10 could be transferred in emergency situations or when none of the control entities in the list is able to exercise control of the drone 10. For example, such a default control entity of the drone 10 is the control entity having the lowest transfer priority level, i.e. the last one that will be selected in accordance with the priority levels assigned to each control entity. In another implementation, the default drone control entity is explicitly identified by means of a dedicated parameter such as a flag. The identity of the default control entity of the drone may change over time. This information may be modified as described with reference to step E6 previously before.

Once the list L10 of control entities intended to exercise control of the drone 10 has been created, it is possible to use it in the context of a procedure for transferring control of the drone 10 from a first control entity 11 exercising control of the drone 10 to a second control entity 12 belonging to the list L10. The control of the drone 10 being exercised by the control entity 11, it should be understood that the transfer priority level NP11 associated with this control entity 11 is the highest level amongst all control entities of the list L10.

The different steps of such a method for transferring control of the drone 10 are described with reference to [FIG. 3].

In a step G1, the server 14 of the system SGC for managing the connectivity of remotely-controlled systems detects an event ET triggering the transfer of control of the drone 10. Although the server 14 is mentioned herein, the transfer method may be implemented by another piece of equipment of the system SGC for managing the connectivity of remotely-controlled systems.

The event ET triggering the transfer of control of said drone belongs to the following list including inter alia:
a crossing of a geographical limit, for example the drone 10 enters the airspace of an airport,
the control entity 11 encounters a technical problem and requests to transfer control of the drone 10,
a cutoff in the transmission channel(s) established between the control entity 11 exercising control over the drone 10 and the system SGC for managing the connectivity of remotely-controlled systems,
a straight line distance between the drone 10 and the control entity larger than a given value,
working hours of a pilot of the control entity,
an insufficient service quality of the communication channel(s) established between the control entity 11 exercising control over the drone 10 and the system SGC for managing the connectivity of remotely-controlled systems, etc.

The event ET may also be a combination of the individual events of the list hereinabove.

The event ET triggering the transfer of control of the drone may also be the reception by the server 14 of a request DT for transferring control of the drone 10 represented by the step G1′ in FIG. 3.

Such a control transfer request DT may be emitted by a piece of equipment belonging to the drone traffic management system UTM, by a piece of equipment belonging to the drone fleet management entity 15 to which the drone 10 belongs, or by the control entity 11 itself.

Following the detection of an event triggering the transfer of control of the drone 10 from the control entity 11 to another control entity, the server 14 triggers the procedure for transferring control of the drone in a step G2.

In a first embodiment of the transfer method, during a step G3, the server 14 browses the list L10 of control entities in order to determine the control entity to which control of the drone should be transferred.

In order to identify the control entity to which control of the drone should be transferred, the server 14 uses the parameters relating to the conditions for transferring control of the drone 10 associated with each control entity belonging to the list L10, parameters representative of the event triggering the transfer of control of the drone and finally the transfer priority level NP associated with each control entity present in the list L10.

Once the server 14 has identified a control entity 12 meeting the criteria for transferring control of the drone 10, the transfer of control of the drone 10 to the control entity 12 is triggered.

In a second embodiment of the transfer method, the identity of the control entity to which control of the drone should be transferred is indicated in the transfer request DT. In this second embodiment, the server 14 verifies, during a step G4, that the control entity 12 meets the control transfer criteria. For this purpose, the server 14 uses the parameters relating to conditions for transferring control of the drone 10 associated with each control entity belonging to the list L10, the parameters representative of the event triggering the transfer of control of the drone and finally the transfer priority level NP associated with a set of control entities present in the list L10 in order to ensure that the control entity 12 is able to exercise control of the drone 10 with regards to the circumstances that have led to triggering of the transfer procedure.

Once the server 14 has established that the control entity 12 meets the criteria for transferring control of the drone 10, the transfer of control of the drone 10 to the control entity 12 is triggered.

Thus, during a step G5 common to the first and to the second embodiment of the transfer method, the server 14 modifies the entries of the list L10 corresponding respectively to the control entity 11 and to the control entity 12 in order to reflect the transfer of control of the drone from one to another.

In a first implementation of step G5, the server 14 modifies the value of the parameter representing a status of exercise of control of the drone 10 for the control entity 11 and for the control entity 12. Thus, the flag associated with the control entity 11 has its status change from ACTIVE to INACTIVE while the flag associated with the control entity 12 has its status change from INACTIVE to ACTIVE reflecting the transfer of control of the drone 10. In this implementation of the transfer method, the transfer priority level NP associated with each control entity is not modified.

In this first implementation, an event triggering the transfer of control of the drone 10 may be the detection of a cutoff in the or one of the transmission channels supporting the communication session established between the drone 10 and the control entity whose flag has the status ACTIVE in the list L10.

In a second implementation of step G5, the server 14 modifies the value of the transfer priority level NP11 of the control entity 11 and the value of the transfer priority level NP12 of the control entity 12 in order to reflect the transfer of control of the drone 10. For this purpose, the value of the transfer priority level NP12 of the control entity 12 is modified to reach the highest possible value because the control entity 12 is the control entity now exercising control of the drone 10 and should therefore have the highest transfer priority level value NP. At the same time, the value of the transfer priority level NP11 of the control entity 11 is modified so as to be lower than the value of the transfer priority level NP12 of the control entity 12. In an alternative implementation, the value of the transfer priority level NP11 of the control entity 11 and the value of the transfer priority level NP12 of the control entity 12 are permuted.

In this second implementation, following the modification of the values of the transfer priority levels NP11 and NP12 of the control entities 11 and 12, the server 14 resolves, in a step E6, transfer priority conflicts that might occur between at least two control entities of the list L10 associated with the same transfer priority level as described with reference to step E5 of the method for managing the list L10 described hereinabove with reference to [FIG. 2].

Where appropriate, these two implementations may be combined.

During an optional step G7, the server 14 triggers the establishment of at least one control session between the control entity 12 and the drone 10 throughout which the control entity 12 actually exercises control of the drone 10 by transmitting a control data stream. This control session is supported by one or more communication channel(s) established between the control entity 12 and the drone 10. The transmission of the control data stream by the control entity 12 contributes to the termination of the transmission of the control data stream by the control entity 11 thereby putting an end to the exercise of control of the drone 10 by the control entity 11. For example, the server 14 puts an end to the transmission of the control stream by the control entity 11 when it is informed that the second control stream transmitted by the control entity 12 is instantiated. The server 14 may also use other information, for example originating from the system SGC for managing the connectivity of remotely-controlled systems or from a third-party communication network to ensure the transfer of control of the drone 10 between the control entity 11 and the control entity 12 such that the drone 10 is only controlled at a given instant by a single control stream. Indeed, a drone 10 cannot support the reception of two separate control data streams simultaneously. Thus, it is certain that at a given instant one and only one control entity actually exercises control of the drone 10 and is responsible for its flight.

For example, a use case is described hereinafter. A drone 10 patrols in an automated manner over an industrial site, when an anomaly is detected on the site. Hence, an expert should verify this anomaly. Consequently, a human pilot is required to proceed with a manual inspection of the site.

During routine flight and before the detection of the anomaly, the list L10 contains the following elements:
control entity 1—automated pilot—priority level=1st->Active
control entity 2—human pilot—priority level=2nd
control entity 3—by default—priority level=3rd

Following the detection of the anomaly, the server 14 receives a request DT for transferring control of the drone 10. This control transfer request DT is emitted by the control entity 11 or by the drone 10, which indicates that the control entity 1 should be replaced by a control entity whose pilot is a human.

The server 14 then browses the list L10 and identifies the control entity 2 as meeting the needs expressed in the transfer request DT. The server 14 then modifies the transfer priority levels associated with the control entities 1 and 2 and/or modifies the flag representing the status of exercise of control of the drone 10 of each control entity 1 and 2. Afterwards, the server 14 triggers the establishment of a control session between the control entity 2 and the drone 10, throughout which the control entity 2 effectively exercises control of the drone 10 by transmitting a control data stream. In parallel with the transmission of the control data stream by the control entity 2, the server 14 contributes to the termination of the transmission of the control data stream transmitted by the control entity 1.

At the end of the procedure, the list L10 contains the following elements:
control entity 2—human pilot—priority level=1st->Active
control entity 1—automated pilot—priority level=2nd
control entity 3—by default—priority level=3rd

Later on, the system SGC for managing the connectivity of the remotely-controlled systems detects that the control session established between the control entity 2 and the drone 10 is lost or that the service quality required for the transmission channel(s) established between the control entity 2 and the drone 10 can no longer be guaranteed. This leads the server 14 to modify the priority of the control entity 2, for example to set it to the minimum level, which triggers a new procedure for transferring control of the drone 10.

The server 14 then browses the list L10 and identifies the control entity 1 as having the highest transfer priority level. The server 14 then modifies the flag representing the status of exercise of control of the drone 10 of each control entity 1 and 2. Afterwards, the server 14 triggers the establishment of a control session between the control entity 1 and the drone 10 throughout which the control entity 1 effectively exercises control of the drone 10 by transmitting a control data stream. The transmission of the control data stream by the control entity 1 by the server 14 contributes to the termination, still implemented by the server 14, of the transmission of the control data stream transmitted by the control entity 2.

At the end of the procedure, the list L10 contains the following elements:
control entity 1—automated pilot—priority level=1st->Active
control entity 3—by default—priority level=2nd
control entity 2—human pilot—priority level=3rd

FIG. 4 represents a server 14 able to implement the methods for managing a list of control entities and for transferring control of a drone objects of the invention.

A server 14 may comprise at least one hardware processor 41, one storage unit 42, one interface 43, and at least one network interface 44 which are connected together throughout a bus 45. Of course, the constituent elements of the server 14 may be connected by means of a connection other than a bus.

The processor 41 controls the operations of the server 14. The storage unit 42 stores at least one program for implementing the method according to one embodiment to be executed by the processor 41, and various data, such as parameters used for calculations performed by the processor 41, intermediate data of calculations performed by the processor 41, etc. The processor 41 may be any known and suitable hardware or software, or a combination of hardware and software. For example, the processor 41 may be formed by dedicated hardware such as a processing circuit, or by a programmable processing unit such as a central processing unit (Central Processing Unit) which executes a program stored in a memory of the latter.

The storage unit 42 may be formed by any suitable means capable of storing the program or programs and data in a computer-readable manner. Examples of storage unit 42 include non-transitory computer-readable storage media such as semiconductor memory devices, and magnetic, optical, or magneto-optical recording media loaded into a read-and-write unit.

The interface 43 provides an interface between the server 14 and the equipment of the drone traffic management system UTM, the equipment of the drone fleet management entity 15 and the other equipment of the system SGC for managing the connectivity of remotely-controlled systems.

At least one network interface 44 provides a connection between the server 14 and the drone 10 and the control entities 11, 12.

1. A method for transferring to a second control entity control of a remotely-controlled vehicle, called a drone, from a first control entity exercising control of the drone via a first control data stream transmitted throughout a first communication session established between said first control entity and the drone, wherein said method is implemented by a device and comprises:
detecting an event triggering the transfer of control of said drone,
determining said second control entity by using a list of control entities possessing an authorization for control of said drone, said list comprising at least one parameter relating to a condition for transferring control of said drone to said second control entity, and
establishing transmission of a second control data stream throughout a second communication session between the drone and said second control entity, the establishment of the transmission of said second control data stream throughout the second communication session contributing to an end of the control exercised by the first control entity over the drone.

2. The method for transferring control of a drone according to claim 1, wherein the at least one parameter relating to a condition for transferring control of said drone to said second control entity is a transfer priority level associated with said second control entity.

3. The method for transferring control of a drone according to claim 1, wherein said second entity is also determined by using a parameter representative of the event triggering the transfer of control of the drone.

4. The method for transferring control of a drone according to claim 1, wherein the at least one parameter relating to the condition for transferring control of said drone to said second control entity is a parameter representing a status of exercise of control of the drone by said second entity, said method comprising:
modifying said parameter representing a status of exercise of control of the drone by said second entity from inactive to active, triggering the transmission of the second control data stream.

5. The method for transferring control of a drone according to claim 1, wherein said method comprises modifying a priority level associated with the first control entity or with the second control entity in said list of control entities intended to control said drone, the modification of the priority level associated with the first control entity or with the second control entity triggering the transmission of the second control data stream.

6. The method for transferring control of a drone according to claim 1, wherein the event triggering the transfer of control of said drone belongs to the following list consisting of:
a crossing of a geographical limit or an altitude of said drone,
a cutoff in a transmission channel established between the first control entity exercising control over the drone and a drone connectivity management system, said transmission channel supporting a communication session established between the first control entity exercising control over the drone and the drone,
an insufficient service quality of the transmission channel established between the first control entity exercising control over the drone and a drone connectivity management system,
a reception of a request to transfer control of the drone emitted by a drone traffic management entity,
a reception of a request to transfer control of the drone emitted by a drone fleet management entity to which the drone belongs,
a reception of a request to transfer control of the drone emitted by a control entity belonging to a list of control entities,
a reception of a request to transfer control of the drone emitted by the drone itself,
an automatic detection of an alert on an infrastructure that justifies a control entity change,
a detection of an injunction from accredited authorities.

7. A method for managing a list of remotely-controlled vehicle control entities to control a remotely-controlled vehicle, called a drone, wherein said method is implemented by a device and comprises:
receiving a request to modify said list of control entities relating to a control entity,
verifying possession, by said control entity, of an authorization for control of said drone,
in response to said control entity possessing an authorization for control of said drone, recording in an entry in said list of control entities comprising at least an identifier of said control entity, and at least one parameter relating to a condition for transferring the control of said drone to said control entity.

8. The method for managing a list of drone control entities according to claim 7, wherein the at least one parameter relating to a condition for transferring control of said drone to said control entity comprises:
a transfer priority level associated with said control entity,
at least one rule for transferring control of the drone to said control entity.

9. The method for managing a list of drone control entities according to claim 7, wherein the list of control entities further comprises at least one parameter relating to an access right of said entity to the content of said list.

10. The method for managing a list of remotely-controlled vehicle control entities according to claim 8, wherein a control entity of the list of remotely-controlled vehicle control entities that is associated with a transfer priority level lower than the transfer priority levels associated with the other control entities present in the list is a default control entity of said drone.

11. The method for managing a list of drone control entities according to claim 8, wherein the method further comprises resolving transfer priority conflicts between at least two control entities in the list of remotely-controlled vehicle control entities, which are associated with the same transfer priority level, said resolving comprising:
identifying amongst said at least two control entities a control entity intended to be associated with a transfer priority level modified by using a parameter belonging to the following list comprising:
a parameter representative of a service quality required by said control entity,
a security parameter,
modifying the transfer priority level associated with said control entity to another priority level.

12. A device comprising:
at least one processor; and
at least one non-transitory computer readable medium comprising instructions stored thereon which when executed by the at least one processor configure the device to perform a transfer to a second control entity of control of a remotely-controlled vehicle, called a drone, from a first control entity exercising control of the drone via a first control data stream transmitted throughout a first communication session established between said first control entity and the drone, wherein the transfer comprises:
detecting an event triggering the transfer of control of said drone,
determining said second control entity by using a list of control entities possessing an authorization for control of said drone comprising at least parameters relating to conditions for transferring control of said drone to said second control entity, and
establishing transmission of a second control data stream throughout a second communication session between the drone and said second control entity, the establishment of the transmission of said second control data stream throughout the second communication session contributing to an end of the control exercised by the first control entity over the drone.

13. A device comprising:
at least one processor; and
at least one non-transitory computer readable medium comprising instructions stored thereon which when executed by the at least one processor configure the device to manage a list of remotely-controlled vehicle control entities to control a remotely-controlled vehicle, called a drone, wherein the managing comprises:
receiving a request to modify said list of control entities relating to a control entity,
verifying possession, by said control entity, of an authorization for control of said drone, and
recording an entry in said list of control entities comprising at least an identifier of said control entity, and at least one parameter relating to a condition for transferring control of said drone to said control entity, when said control entity possesses an authorization for control of said drone.

14. A non-transitory computer readable medium comprising a computer program product stored thereon comprising program code instructions for implementing the method according to claim 1, when executed by a processor of the device.

15. A non-transitory computer readable medium comprising a computer program product stored thereon comprising program code instructions for implementing the method according to claim 7, when executed by a processor of the device.
